(19) United States
(12) Patent Application Publication
(10) Pub. No.: US 2016/0116782 A1
(43) Pub. Date: Apr. 28, 2016

(54) SINGLE-SUBSTRATE DISPLAY DEVICE AND MANUFACTURING METHOD THEREOF

(71) Applicant: Samsung Display Co., Ltd., Yongin-City (KR)

(72) Inventor: Si Kwang KIM, Daegu (KR)

(21) Appl. No.: 14/640,394

(22) Filed: Mar. 6, 2015

(30) Foreign Application Priority Data
Oct. 22, 2014 (KR) 10-2014-0143454

(51) Int. Cl. G02F 1/1339; G02F 1/1335; G02F 1/1333; G02F 1/1337; G02F 1/1368; G02F 1/1341

(52) U.S. Cl. CPC G02F 1/13394; G02F 1/1368; G02F 1/1341; G02F 1/133377; G02F 1/1337; G02F 1/133512

(57) ABSTRACT

A display device is presented. The device includes: a substrate including a plurality of pixels disposed in a matrix configuration and having a thin film transistor positioned thereon; a pixel electrode connected to the thin film transistor and positioned in one of the pixels; a roof layer including an opening and an injecting hole positioned to be spaced apart from the pixel electrode on the pixel electrode, the roof layer enclosing a micro-cavity holding a liquid crystal layer; and a first supporting member formed at a first edge of the micro-cavity that is adjacent to the opening, wherein the opening is smaller than the injecting hole. The supporting members prevent any sagging of the roof layer and are formed at two edges of neighboring micro-cavities that face each other. As the supporting members are positioned where alignment material may aggregate, they reduce the aggregation that causes negative effects on the image.

### CROSS-REFERENCE TO RELATED APPLICATION

This application claims priority to and the benefit of Korean Patent Application No. 10-2014-0143454 filed in the Korean Intellectual Property Office on Oct. 22, 2014, the entire contents of which are incorporated herein by reference.

### BACKGROUND

(a) Field

The present disclosure relates to a display device and a manufacturing method thereof.

(b) Description of the Related Art

Liquid crystal display (LCD) is a type of a flat panel display (FPD) that is widely used today. A liquid crystal display generates electric field by applying different potentials to pixel electrodes and common electrodes of a liquid crystal display panel. A liquid crystal layer is formed between a lower panel and an upper panel, and application of different potentials changes the arrangement of liquid crystal molecules in the liquid crystal layer to adjust polarization of incident light, thereby displaying an image.

Two panels constituting the liquid crystal display panel of the liquid crystal display may include the lower panel on which thin film transistors are arranged and the upper panel which is opposite to the lower panel. The lower panel is provided with a gate line transferring a gate signal, a data line transferring a data signal, the thin film transistor connected to the gate line and the data line, the pixel electrode connected to the thin film transistor, and the like. The upper panel may be provided with a light shielding member, a color filter, the common electrode, and the like, and at least one of the above-mentioned components may also be formed on the lower panel.

In a typical liquid crystal display, two substrates are used for the lower panel and the upper panel and a process of forming the above-mentioned components on each of the substrates and coupling them to each of the substrates is required. As a result, the liquid crystal display becomes heavy and thick, and problems related to cost, processing time, and the like may arise. Recently, liquid crystal display including a tunnel type structure that holds liquid crystals has been developed to overcome the above problems associated with the two-substrate structure.

The above information disclosed in this Background section is only for enhancement of understanding of the background of the inventive concept and therefore it may contain information that does not form the prior art that is already known in this country to a person of ordinary skill in the art.

### SUMMARY

The present device and method provide a display device and a manufacturing method that allows controlling an aggregation position of alignment material by adjusting a position of a supporting member and adjusting a width of a liquid crystal injecting hole in the display device which is manufactured using one substrate and improving an aperture ratio at the same time.

In one aspect, the present inventive concept provides a display device including: a substrate including a plurality of pixels disposed in a matrix configuration and having a thin film transistor positioned thereon; a pixel electrode connected to the thin film transistor and positioned in one of the pixels; a roof layer including an opening and an injecting hole positioned to be spaced apart from the pixel electrode on the pixel electrode, the roof layer enclosing a micro-cavity holding a liquid crystal layer; and a first supporting member formed at a first edge of the micro-cavity that is adjacent to the opening, wherein the opening is smaller than the injecting hole.

The display device may further include an alignment layer positioned on an inner surface of the micro-cavity.

The opening may have a width of 10 to 30 μm, and the injecting hole may have a width of 40 to 60 μm.

The supporting member may be formed of the same material as that of the roof layer.

Where the opening is between the first edge and a second edge of neighboring micro-cavities, the second supporting member may be formed adjacent to the second edge.

A plurality of supporting members may be formed at each of the first edge and the second edge of the micro-cavities.

The alignment layer may aggregate around the first and second supporting members.

The opening and the injecting hole may be provided with light shielding members, and the light shielding members positioned in the opening and the injecting hole may have the same width.

In another aspect, the present inventive concept provides a manufacturing method of a display device including: forming a thin film transistor on a substrate including a plurality of pixels disposed in a matrix configuration; in one of the pixels, forming a pixel electrode connected to the thin film transistor; forming a sacrificial layer on the pixel electrode and forming a hole part by removing a portion of the sacrificial layer; forming a roof layer and supporting members together on the sacrificial layer and the hole part; forming an opening and an injecting hole to expose a portion of the sacrificial layer; forming a micro-cavity by removing the sacrificial layer; and forming a liquid crystal layer in the micro-cavity by injecting a liquid crystal material through the injecting hole, forming a first supporting member at a first edge of the opening wherein the opening is smaller than the injecting hole.

The first supporting member may be formed with the same material as the roof layer.

Where the opening is between the first edge and a second edge of neighboring micro-cavities, the second supporting member may be formed adjacent to the second edge.

More than one supporting members may be formed at each of the first edge and the second edge.

The manufacturing method may further include, before the injecting of the liquid crystal material, forming an alignment layer on an inner surface of the micro-cavity by injecting an alignment liquid through the injecting hole.

The method may further include forming light shielding members at positions corresponding to the opening and the injecting hold, wherein the light shielding members formed at the positions corresponding to the opening part and the injecting hole have the same width.

The manufacturing method may further include sealing the micro-cavity by forming cover layer on the roof layer.

In yet another aspect, the inventive concept includes a display device including liquid crystal molecules contained in microcavities. A first row of microcavities are arranged on a substrate, a second row of microcavities are arranged on the substrate, wherein the second row of microcavities is spaced apart from the first row of microcavities by a first horizontal valley having a width D1. A third row of microcavities are arranged on the substrate spaced apart from the second row of microcavities by a second horizontal valley having a width D2 different from D1. Supporting members are formed at the edges of the microcavities adjacent to the first horizontal valley but not the second horizontal valley.

Dimensions of the microcavities may vary depending on their locations.

Since the supporting members are formed at the facing edges of two different micro-cavities while preventing deformation of the roof layer by the supporting members, the position in which the aggregation phenomenon of the alignment material occurs may be controlled.

In addition, since a region occupied by the light shielding member is reduced by forming the supporting members adjacent to a narrow opening, the aperture ratio may be improved.

### BRIEF DESCRIPTION OF THE DRAWINGS

FIGS. 1, 2A, and 2C are layout views schematically illustrating a display device according to an exemplary embodiment of the present disclosure.

FIG. 2B is a cross-sectional view of a display device according to an exemplary embodiment of the present disclosure.

FIG. 3 is a plan view illustrating one pixel of the display device according to an exemplary embodiment of the present disclosure.

FIG. 4 is a plan view illustrating another pixel of the display device according to an exemplary embodiment of the present disclosure.

FIG. 5 is a cross-sectional view taken along the line V-V of FIG. 1.

FIG. 6 is a cross-sectional view taken along the line VI-VI of FIG. 1.

FIG. 7 is a cross-sectional view taken along the line VII-VII of FIG. 1.

FIGS. 8, 9, 10, 11, and 12 are cross-sectional views sequentially illustrating a manufacturing method of a display device according to an exemplary embodiment of the present disclosure.

### DETAILED DESCRIPTION OF THE EMBODIMENTS

The present inventive concept will be described more fully hereinafter with reference to the accompanying drawings, in which exemplary embodiments are shown. As those skilled in the art would realize, the described embodiments may be modified in various different ways, all without departing from the spirit or scope of the present inventive concept.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Hereinafter, a display device according to an exemplary embodiment of the present disclosure will be described with reference to the accompanying drawings.

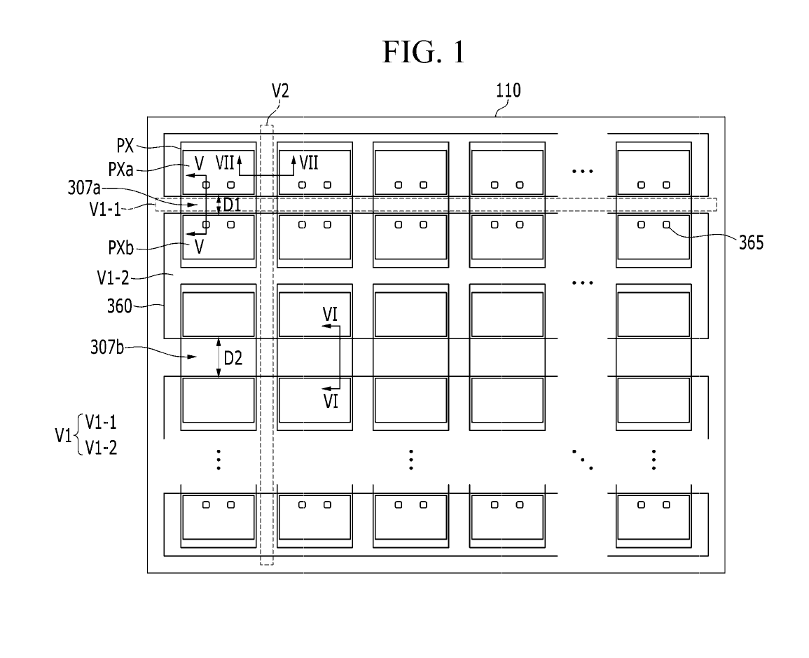

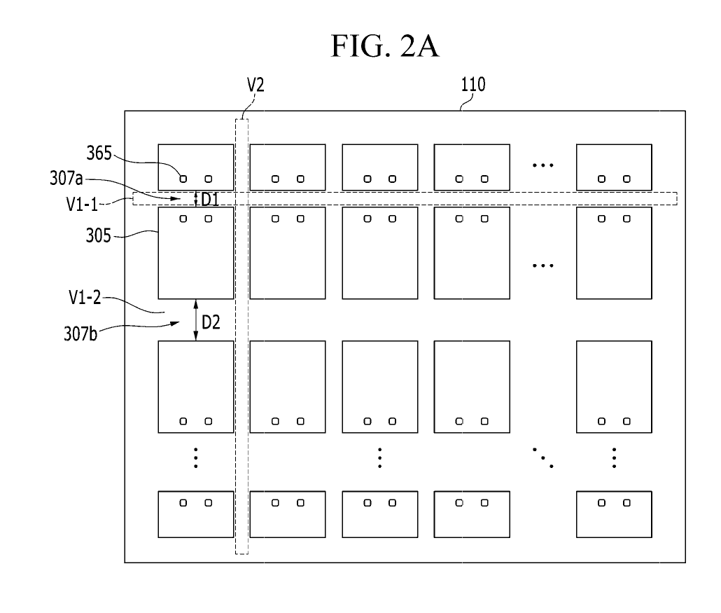

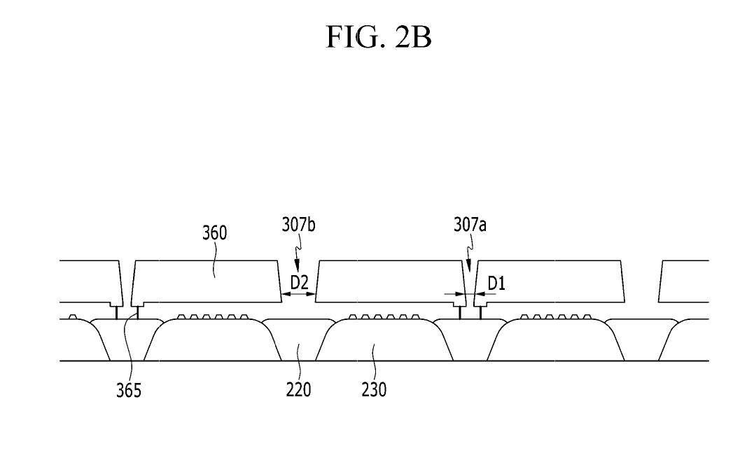

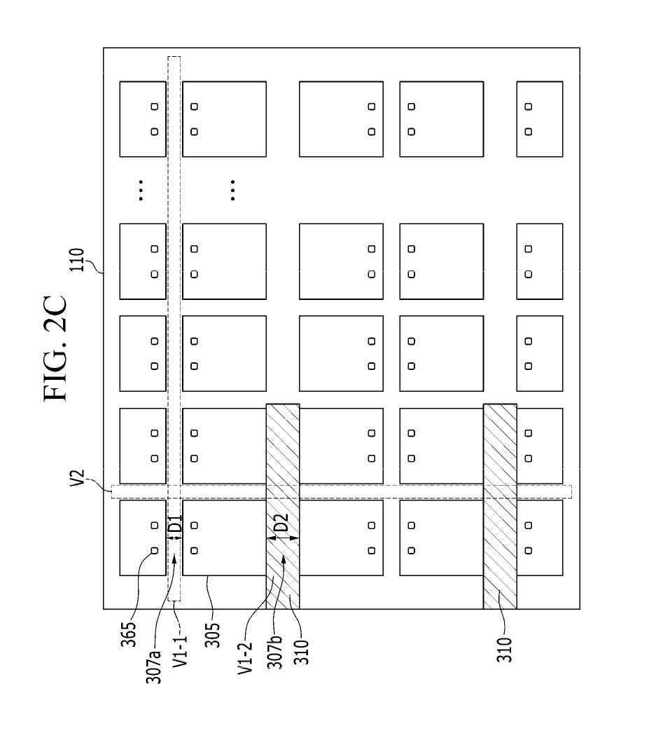

First, a display device according to an exemplary embodiment of the present disclosure will be schematically described with reference to FIGS. 1 and 2.

FIGS. 1, 2A, 2B, and 2C are schematically illustrate a display device according to an exemplary embodiment of the present inventive concept.

FIG. 1 illustrates a position of a supporting member based on a pixel, FIG. 2A illustrates a position of forming the supporting member based on a micro-cavity, FIG. 2B illustrates a cross-sectional view in a column direction of FIG. 2A, and FIG. 2C illustrates an injecting path of liquid crystal.

Referring to FIGS. 1, 2A, and 2B, the display device according to an exemplary embodiment of the present inventive concept includes a substrate 110 formed of a transparent insulator such as glass, plastic, or the like, and a roof layer 360 formed on the substrate 110.

The substrate 110 includes a plurality of pixels PX. The plurality of pixels PX are disposed in a matrix including a plurality of pixel rows and a plurality of pixel columns. Each pixel PX may include a first sub-pixel PXa and a second sub-pixel PXb. The first sub-pixel PXa and the second sub-pixel PXb may be vertically disposed. As used herein, directional indicators “vertical” and “horizontal” indicate the directions in which columns and rows extend, respectively.

A horizontal valley V1 is positioned between the first sub-pixel PXa and the second sub-pixel PXb along a pixel row direction and vertical valleys V2 are positioned between the plurality of pixel columns.

The roof layer 360 may be formed along the plurality of pixel rows. That is, the roof layer 360 is removed from the horizontal valleys V1, an opening 307a and an injecting hole 307b exposing the micro-cavity 305 covered by the roof layer 360 to the outside are formed in the horizontal valleys V1.

The opening 307a is an opening that connects the inside of the micro-cavity 305 to the outside. However, the opening 307a is not used for injecting the liquid crystal into the micro-cavity 305. The injecting hole 307b, which is also an opening that connects the inside of the micro-cavity 305 to the outside, is used for injecting the liquid crystal into the micro-cavity 305.

Each of the first sub-pixel PXa and the second sub-pixel PXb may include one opening 307a or injecting hole 307b, and the opening 307a and the injecting hole 307b of the respective sub-pixels PXa and PXb may be positioned to face each other. For example, one of the opening 307a or the injecting hole 307b is formed at a lower edge (e.g., “a first edge”) of the first sub-pixel PXa and the other of the opening 307a or the injecting hole 307b is formed at an upper edge (e.g., “a second edge”) of the second sub-pixel PXb.

The opening 307a and the injecting hole 307b are repeatedly formed in an alternating manner (e.g., the opening 307a, the injecting hole 307b, the opening 307a, and the injecting hole 307b) along a vertical direction of the pixel PX. For example, if pixels PX1, PX2, PX3, and PX4 were arranged in a vertical direction going from top to bottom, the first pixel PX1 and the third pixel PX3 would have an opening 307a formed at the lower edges of their respective first sub-pixels PXa, and the second pixel PX2 and the fourth pixel PX4 would have an injection hole 307b formed at the upper edges of their respective second sub-pixels PXb.

The micro-cavity 305 is formed below the roof layer 360. The roof layer 360 may droop or sag above the opening 307a or the injecting hole 307b where there is no supporting sidewall of the micro-cavity 305. In order to prevent the sagging, supporting members 365 supporting the roof layer 360 are formed to near the opening 307a and the injecting hole 307b. As a result, the sagging of the roof layer 360 around the opening 307a/injecting hole 307b may be prevented.

In addition, since the opening 307a or the injecting hole 307b is not formed in a horizontal direction of the roof layer 360 and a side wall of the roof layer 360 partitions the micro-cavity 305 in the row direction, the side wall of the roof layer 360 may also prevent the sagging of the roof layer 360 together with the supporting member 365.

The supporting members 365 are each formed at the edges of two different micro-cavities 305 that is closest to the other sub-pixel PXa/PXb of the particular pixel PX. A plurality of micro-cavities 305 are disposed in a matrix configuration including a plurality of rows and a plurality of columns. For example, the micro-cavity 305 may have a quadrangular shape, with a lower edge of a micro-cavity 305 of a first row and an upper edge of a micro-cavity 305 of a second row facing each other. In this case, the supporting members 365 are each formed at the lower edge (e.g., “the first edge”) of the micro-cavity 305 of the first row and the upper edge (e.g., “the second edge”) of the micro-cavity 305 of the second row that face each other.

As illustrated in FIG. 1, FIG. 2A, and FIG. 2C, the rows of pixels PX do not correspond with rows of micro-cavities 305. While the first sub-pixel PXa and the second sub-pixel PXb of a single pixel PX are separated by the horizontal valley V1, the horizontal valley V1 does not cut across a micro-cavity 305. The micro-cavity 305 extends between a first horizontal valley V1-1 having a width D1 and a second horizontal valley V1-2 having a width D2. In doing so, the micro-cavity 305 spans across the second sub-pixel PXb of one pixel and a first sub-pixel PXa of a neighboring pixel.

The opening 307a and the injecting hole 307b are formed at the upper and lower edges of the respective micro-cavities 305. As the upper edge and the lower edge (also referred to herein as the first edge and the second edge) of one micro-cavity 305 face each other, these edges may herein be referred to as “facing edges.” The opening 307a and the injecting hole 307b may be each formed at the upper edge and the lower edge of the micro-cavity 305, respectively. In this case, the supporting members 365 may be formed adjacent to the opening 307a formed at the two facing edges of each micro-cavity 305, but not by the injecting hole 307b. As a non-limiting example, the supporting members 365 are formed at lower edges of micro-cavities 305 of odd-numbered rows and are not formed at upper edges thereof. In addition, the supporting members 365 are formed at upper edges of micro-cavities 305 of even-numbered rows and are not formed at lower edges thereof.

The horizontal valleys V1 (some having a width D1 and others having a width D2) are formed between the micro-cavities 305 positioned in different rows. Describing a position of the supporting member 365 based on the horizontal valley V1, the supporting member 365 is formed adjacent to both sides of the horizontal valley V1. The supporting member 365 is formed adjacent to a first horizontal valley having a width D1 of every other horizontal valley V1 but not formed adjacent to a second horizontal valley V1 having a width D2. The first horizontal valley V1 is defined by a first edge of the first sub-pixel PX1 and a second edge of the second sub-pixel PXb of the same pixel PX. For example, in one embodiment where first horizontal valley V1 and the second horizontal valley V1 are arranged in an alternating manner, the supporting member 365 is formed adjacent to both the first and second edges of the first horizontal valley. No supporting members 365 are formed along the edges defining the second horizontal valley V1.

A width D1 of the opening 307a formed in the first horizontal valley and a width D2 of the injecting hole 307b formed in the second horizontal valley in the display device according to an exemplary embodiment are different from each other. Here, the widths D1 and D2 mean a shortest distance between the facing edges of two neighboring micro-cavities 305 (see FIG. 2A).

The width D1 of the opening 307a formed to be adjacent to the supporting member 365 is formed to be smaller than the width D2 of the injecting hole 307b. The width D1 of the opening 307a is formed to be small in order to increase an aperture ratio and the width D2 of the injecting hole 307b is formed to be larger than the width D1 of the opening 307a in order to smoothly inject an alignment material and a liquid crystal material.

That is, referring to FIG. 2C, the liquid crystal 310 is not injected into the opening 307a having a width D1 and is injected through the injecting hole 307b having the width D2 that is wider than D1.

Here, the width D1 of the opening 307a may be 10 to 30 μm and the width D2 of the injecting hole 307b may be 40 to 60 μm, but are not limited thereto.

A case in which one micro-cavity 305 is formed across the first sub-pixel PXa and the second sub-pixel PXb of the two neighboring pixels PX is described above, but the present device and method are not limited thereto. For example, one micro-cavity 305 may be formed in one pixel PX.

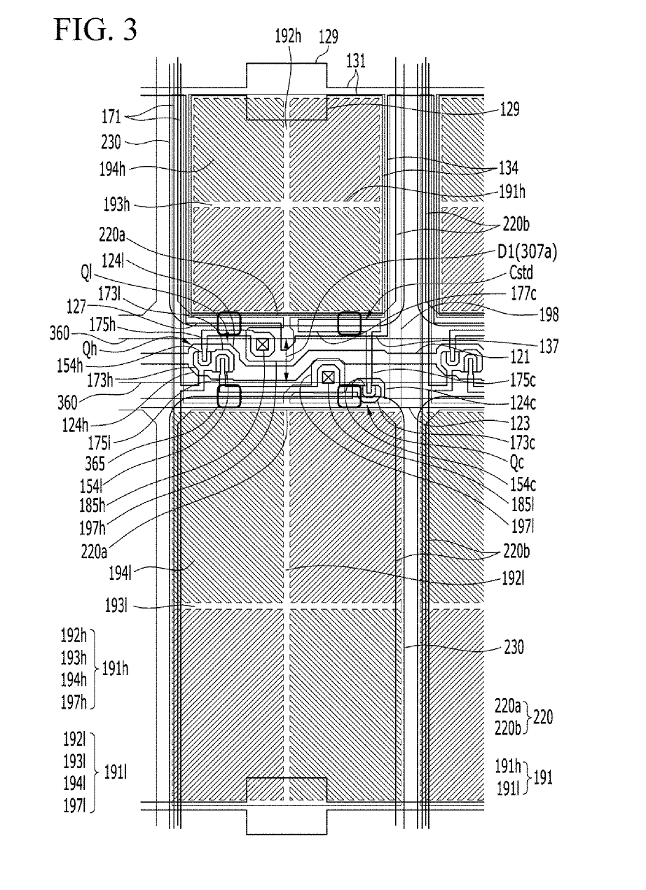

The display device according to an exemplary embodiment will be described in more detail with reference to FIGS. 3 to 7 together with FIGS. 1 and 2A.

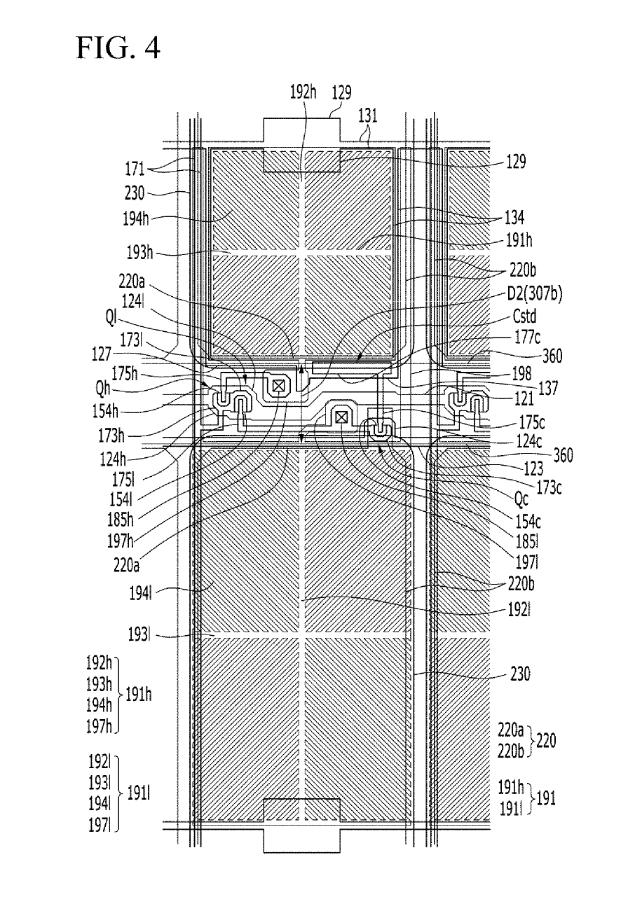

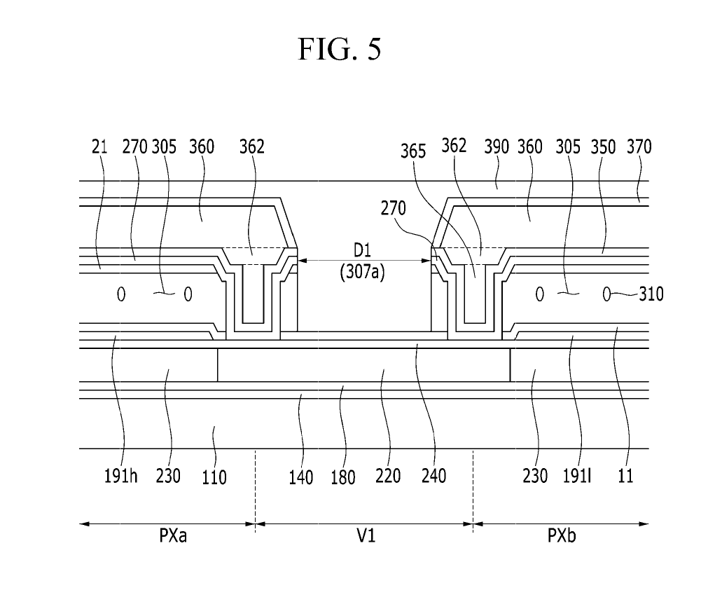

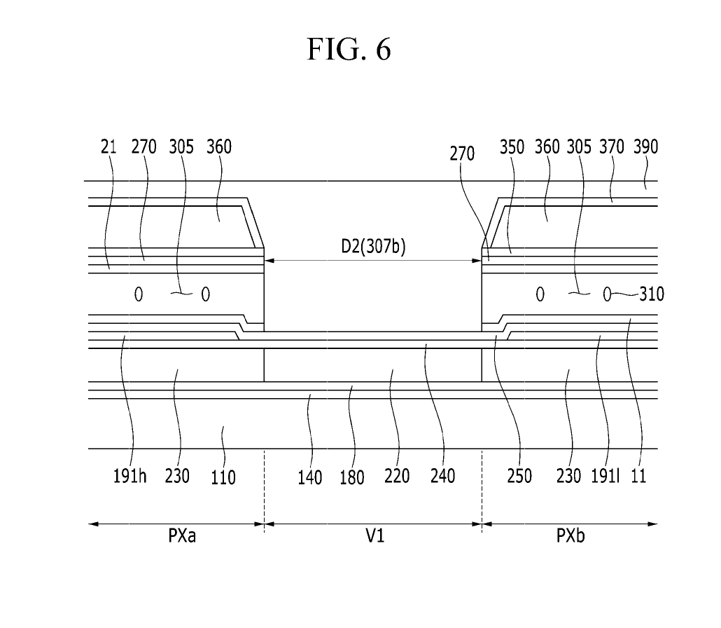

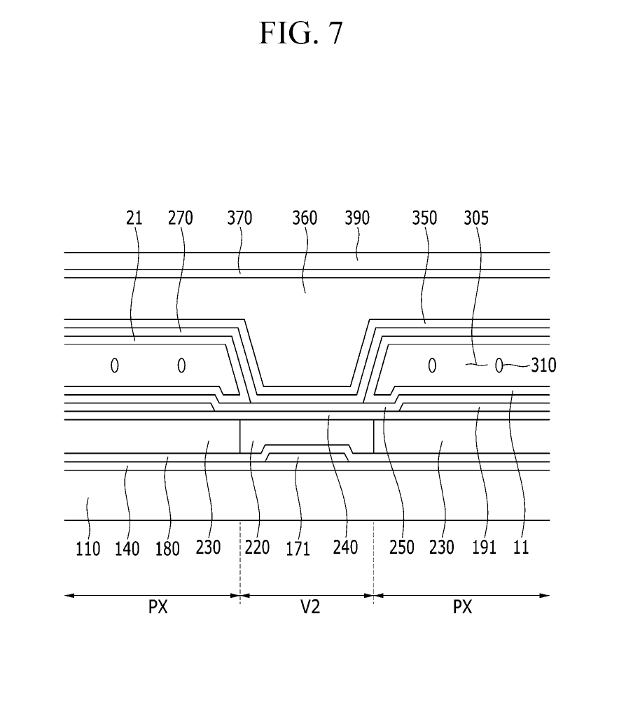

FIG. 3 is a plan view illustrating one pixel of the display device according to an exemplary embodiment and FIG. 4 is a plan view illustrating another pixel of the display device according to an exemplary embodiment. FIG. 3 and FIG. 4 are oriented in consistently with FIG. 1 and FIG. 2A. FIG. 5 is a cross-sectional view taken along the line V-V of FIG. 1 and FIG. 6 is a cross-sectional view taken along the line VI-VI of FIG. 1, and FIG. 7 is a cross-sectional view taken along the line VII-VII of FIG. 1.

FIGS. 3 and 5 illustrate pixels in which the supporting member 365 is formed, and FIGS. 4 and 7 illustrate pixels in which the supporting member 365 is not formed.

Referring to FIGS. 1 to 7, a plurality of gate conductors including a plurality of gate lines 121, a plurality of decompression gate lines 123, and a plurality of sustain electrode lines 131 are formed on the substrate 110.

The gate line 121 and the decompression gate line 123 mainly extend in a horizontal direction and transfer a gate signal. The gate conductor further includes a first gate electrode 124h and a second gate electrode 124l that vertically protrudes from the gate line 121 and a third gate electrode 124c that upwardly protrudes from the decompression gate line 123. The first gate electrode 124h and the second gate electrode 124l are connected to each other to form one protrusion part. Shapes of the first to third gate electrodes 124h, 124l, and 124c may be changed.

The sustain electrode line 131 mainly extends in the horizontal direction and transfers a set voltage such as a common voltage Vcom, or the like. The sustain electrode line 131 includes an expanded sustain electrode 129, a pair of vertical extensions 134 which are downwardly extended to substantially perpendicular to the gate line 121, and a horizontal extension 127 connecting ends of the pair of vertical parts 134 to each other. The horizontal part 127 includes a storage electrode 137 extending downward.

A gate insulating layer 140 is formed on the gate conductors 121, 123, 124h, 124l, 124c, and 131. The gate insulating layer 140 may be made of an inorganic insulating material such as silicon nitride (SiNx), silicon oxide (SiOx), or the like. In addition, the gate insulating layer 140 may be formed of a single film or multiple films.

A first semiconductor 154h, a second semiconductor 154l, and a third semiconductor 154c are formed on the gate insulating layer 140. The first to third semiconductors 154h, 154l, and 154c may be each positioned on the first to third gate electrodes 124h, 124l, and 124c. The first semiconductor 154h and the second semiconductor 154l may be connected to each other and the second semiconductor 154l and the third semiconductor 154c may also be connected to each other. The first semiconductor 154h may also be formed to extend to below a date line 171. The first to third semiconductors 154h, 154l, and 154c may be made of an amorphous silicon, a polycrystalline silicon, a metal oxide, or the like.

Ohmic contacts (not illustrated) are each formed on the first to third semiconductors 154h, 154l, and 154c. The ohmic contacts may be made of silicide or a material such as n+ hydrogenated amorphous silicon which is doped with n-type impurities at high concentration.

Data conductors including the data line 171, a first source electrode 173h, a second source electrode 173l, a third source electrode 173c, a first drain electrode 175h, a second drain electrode 175l, and a third drain electrode 175c are formed on the first to third semiconductors 154h, 154l, and 154c.

The data line 171 transfers a data signal and is mainly extended in a vertical direction to intersect with the gate line 121 and the decompression gate line 123. Each data line 171 includes the first source electrode 173h and the second source electrode 173l which are extended to the first gate electrode 124h and the second gate electrode 124l and connected to each other.

The first drain electrode 175h, the second drain electrode 175l, and the third drain electrode 175c include a wide end portion of one side and an end portion of the other side having a rod shape. The rod type end portions of the first drain electrode 175h and the second drain electrode 175l are partially surrounded by the first source electrode 173h and the second source electrode 173l. The wide end portion of one side of the second drain electrode 175l extends to form the third source electrode 173c which is bent in a ‘U’ shape. The wide end portion 177c of the third drain electrode 175c overlaps with the storage electrode 137 to form a decompression capacitor Cstd, and the rod type end portion thereof is partially surrounded by the third source electrode 173c.

The first gate electrode 124h, the first source electrode 173h, and the first drain electrode 175h form a first thin film transistor Qh together with the first semiconductor 154h, the second gate electrode 124l, the second source electrode 173l, and the second drain electrode 175l form a second thin film transistor Ql together with the second semiconductor 154l, and the third gate electrode 124c, the third source electrode 173c, and the third drain electrode 175c form a third thin film transistor Qc together with the third semiconductor 154c.

The first semiconductor 154h, the second semiconductor 154l, and the third semiconductor 154c may be connected to each other to be linear, and may substantially have the same plane shape as the data conductors 171, 173h, 173l, 173c, 175h, 175l, 175c and the ohmic contacts below thereof, except for channel regions between the source electrodes 173h, 173l, and 173c and the drain electrodes 175h, 175l, and 175c.

The first semiconductor 154h has a portion which is not covered by the first source electrode 173h and the first drain electrode 175h and exposed between the first source electrode 173h and the first drain electrode 175h, the second semiconductor 154l has a portion which is not covered by the second source electrode 173l and the second drain electrode 175l and exposed between the second source electrode 173l and the second drain electrode 175l, and the third semiconductor 154c has a portion which is not covered by the third source electrode 173c and the third drain electrode 175c and exposed between the third source electrode 173c and the third drain electrode 175c.

A passivation layer 180 is formed on the semiconductors 154h, 154l, and 154c exposed between the data conductors 171, 173h, 173l, 173c, 175h, 175l, and 175c and the respective source electrodes 173h, 173l, and 173c, and the respective drain electrodes 175h, 175l, and 175c. The passivation layer 180 may be made of an organic insulating material or an inorganic insulating material, and may be formed of a single film or multiple films.

A color filter 230 is formed in each pixel PX on the passivation layer 180. Each color filter 230 may display one of primary colors such as the three primary colors of red, green and blue. The color filer 230 may also display colors of cyan, magenta, yellow, white, and the like. Unlike those shown, the color filter 230 may also extend in the column direction between the neighboring data lines 171.

A region between the neighboring color filters 230 is provided with a light shielding member 220. The light shielding members 220 may overlap with a boundary part of the pixel PX, the thin film transistor 365, and the supporting member to prevent light leakage. The color filter 230 may be formed in each of the first sub-pixel PXa and the second sub-pixel PXb, and the light shield member 220 may be formed between the first sub-pixel PXa and the second sub-pixel PXb.

The light shield member 220 extend along the gate line 121 and the decompression gate line 123 to vertically expand and includes a horizontal light shielding member 220a covering regions in which the first thin film transistor Qh, the second thin film transistor Ql, the third thin film transistor Qc, and the like are positioned, and a vertical light shielding member 220b extend along the data line 171. That is, the horizontal light shielding member 220a may be formed in the horizontal valley V1 and the vertical light shielding member 220b may be formed in the vertical valley V2. The color filter 230 and the light shielding member 220 may be overlapped with each other in some regions.

The first insulating layer 240 may be further formed on the color filter 230 and the light shielding member 220. The first insulating layer 240 may be made of an inorganic insulating material such as silicon nitride (SiNx), silicon oxide (SiOx), or the like. The first insulating layer 240 serves to protect the color filter 230 and the light shielding member 220 which are made of an organic material, and may be omitted, if necessary.

The first insulating layer 240, the light shielding member 220, and the passivation layer 180 are provided with a first contact hole 185h and a second contact hole 185l, each of which exposes the wide end portion of the first drain electrode 175h and the wide end portion of the second drain electrode 175l.

A pixel electrode 191 is formed on the first insulating layer 240. The pixel electrode 191 may be made of a transparent conductive material such as an indium tin oxide (ITO), an indium zinc oxide (IZO), or the like.

The pixel electrodes 191 are separated from each other, having the gate line 121 and the decompression gate line 123 therebetween, and include a first sub-pixel electrode 191h and a second sub-pixel electrode 191l which are disposed at the top and bottom of the pixel PX based on the gate line 121 and the decompression gate line 123 to neighbor each other in the column direction. That is, the first sub-pixel electrode 191h and the second sub-pixel electrode 191l are separated from each other, having the horizontal valley V1 therebetween, the first sub-pixel electrode 191h is positioned in the first sub-pixel PXa, and the second sub-pixel electrode 191l is positioned in the second sub-pixel PXb.

The first sub-pixel electrode 191h and the second sub-pixel electrode 191l are each connected to the first drain electrode 175h and the second drain electrode 175l through the first contact hole 185h and the second contact hole 185l. Therefore, when the first thin film transistor Qh and the second thin film transistor Ql are in an ON state, data voltage is applied to the first sub-pixel electrode 191h and the second sub-pixel electrode 191l via the first drain electrode 175h and the second drain electrode 175l.

The first sub-pixel electrode 191h and the second sub-pixel electrode 191l have a quadrangular shape, and each of the first sub-pixel electrode 191h and the second sub-pixel electrode 191l includes a cross stem part including horizontal stem parts 193h and 193l and vertical stem parts 192h and 192l intersecting with the horizontal stem parts 193h and 193l. In addition, each of the first sub-pixel electrode 191h and the second sub-pixel electrode 191l includes a plurality of fine branch parts 194h and 194l and protrusion parts 197h and 1971 which upwardly or downwardly protrude from the sides of the sub-pixel electrodes 191h and 191l.

The pixel electrode 191 is divided into four sub-regions by the horizontal stem parts 193h and 193l and the vertical stem parts 192h and 192l. The fine branch parts 194h and 194l obliquely extend from the horizontal stem parts 193h and 193l and the vertical stem parts 192h and 192l, and the extension direction may form an angle of approximately 45° or 135° with the gate line 121 or the horizontal stem parts 193h and 193l. Directions in which the fine stem parts 194h and 194l of the two neighboring sub-regions are extended may be perpendicular to each other.

The first sub-pixel electrode 191h may further include an outer stem part surrounding an outer portion, and the second sub-pixel electrode 191l may further include horizontal parts positioned at upper end and lower end, and left and right vertical parts 198 positioned at left and right of the first sub-pixel electrode 191h. The left and right vertical part 198 may prevent capacitive coupling between the data line 171 and the first sub-pixel electrode 191h.

The arrangement of the pixel, the structure of the thin film transistor, and the shape of the pixel electrode as described above are merely examples, and the present method and device are not limited thereto.

A second insulating layer 250 may be further formed on the pixel electrode 191. The second insulating layer 250 may be made of an inorganic insulating material such as silicon nitride (SiNx), silicon oxide (SiOx), or the like. The second insulating layer 250 serves to protect the pixel electrode 191 and may be omitted in some embodiments.

A common electrode 270 is formed on the pixel electrode 191 to be spaced apart from the pixel electrode 191 by a predetermined distance. The micro-cavity 305 is formed between the pixel electrode 191 and the common electrode 270. That is, the micro-cavity 305 is surrounded by the pixel electrode 191 and the common electrode 270. A width and an area of the micro-cavity 305 may be varied depending on a size and resolution of the display device.

Since the second insulating layer 250 is formed on the pixel electrode 191 even though the common electrode 270 is formed to overlap with the pixel electrode 191, it is possible to prevent the common electrode 270 and the pixel electrode 191 from being in contact with each other and forming a short-circuit.

According to an exemplary embodiment, the common electrode 270 may also be formed immediately on the second insulating layer 250. That is, the micro-cavity 305 is not formed between the pixel electrode 191 and the common electrode 270, and the common electrode 270 and the pixel electrode 191 may be formed having the second insulating layer 250 therebetween. In such a case, the micro-cavity 305 may be formed on the common electrode 270.

The common electrode 270 may be made of a transparent conductive material such as an indium tin oxide (ITO), an indium zinc oxide (IZO), or the like. The common electrode 270 may be applied with a constant voltage, and an electrical field may be formed between the pixel electrode 191 and the common electrode 270.

A first alignment layer 11 is formed on the pixel electrode 191. The first alignment layer 11 may also be formed immediately on the second insulating layer 250 which is not covered by the pixel electrode 191.

A second alignment layer 21 is formed below the common electrode 270 so as to face the first alignment layer 11.

The first alignment layer 11 and the second alignment layer 21 may be formed of a vertical alignment layer and made of an alignment layer forming material (hereinafter, referred to as an alignment material) such as polyimide (PI), polyamic acid, polysiloxane, or the like. The first and second alignment layers 11 and 21 may be connected to each other at the edge of the pixel PX.

A liquid crystal layer made of liquid crystal molecules 310 is formed in the micro-cavity 305 positioned between the pixel electrode 191 and the common electrode 270. The liquid crystal molecule 310 has negative dielectric constant anisotropy and may stand with its major axis oriented perpendicular to the substrate 110 in the absence of electrical field. That is, the vertical alignment may be implemented.

The first sub-pixel electrode 191h and the second sub-pixel electrode 191l to which the data voltage is applied generate the electrical field together with the common electrode 270 to thereby determine a direction of the liquid crystal molecule 310 positioned in the micro-cavity 305 between the two electrodes 191 and 270. An amount of light passing through the liquid crystal layer is changed depending on the direction of the liquid crystal molecule 310 determined as described above.

A third insulating layer 350 is further formed on the common electrode 270. The third insulating layer 350 may be made of an inorganic insulating material such as silicon nitride (SiNx), silicon oxide (SiOx), or the like, and may be omitted in some embodiments.

The roof layer 360 is formed on the third insulating layer 350. The roof layer 360 may be made of an organic material. The micro-cavity 305 is formed below the roof layer 360 and the roof layer 360 may be hardened by a hardening process to maintain a three-dimensional shape of the micro-cavity 305. The roof layer 360 is formed spaced apart from the pixel electrode 191, having the micro-cavity 305 between the roof layer 360 and the pixel electrode 191.

The roof layer 360 is positioned in each pixel PX and the vertical valley V2 along the pixel row, but is not positioned in the horizontal valley V1. That is, the roof layer 360 is not formed between the first sub-pixel PXa and the second sub-pixel PXb (see FIG. 1). The micro-cavity 305 is formed below each roof layer 360 in each of the first sub-pixel PXa and the second sub-pixel PXb, but is not formed below the roof layer 360 in the vertical valley V2. Therefore, the roof layer 360 positioned in the vertical valley V2 may be formed to have a thickness thicker than that of the roof layer 360 positioned in each of the first sub-pixel PXa and the second sub-pixel PXb. A top surface and side surfaces of the micro-cavity 305 are covered by the roof layer 360.

As such, since the opening 307a or the injecting hole 307b is not formed in the row direction of the roof layer 360 and a side wall of the roof layer 360 covers both side surfaces of the micro-cavity 305, the side wall of the roof layer 360 may also prevent the sagging described above, together with the supporting member 365.

The roof layer 360 is provided with the opening 307a and the injecting hole 307b that expose a part of the micro-cavity 305. The opening 307a and the injecting hole 307b may be formed to face each other at the edges of the first sub-pixel PXa and the second sub-pixel PXb as described above. For example, the opening 307a and the injecting hole 307b may be formed to expose side surfaces of the micro-cavity 305 corresponding to a lower edge of the first sub-pixel PXa and an upper edge of the second sub-pixel PXb. Describing positions of forming the opening 307a and the injecting hole 307b based on the micro-cavity 305, the opening part 307a and the injecting hole 307b are formed at two facing edges of the respective micro-cavities 305.

Here, the opening 307a indicates an opening that connects the inside space of the micro-cavity 305 to the outside, but is not used for injection of the liquid crystal. In contrast, the injecting hole 307b indicates an opening that connects the inside of the micro-cavity 305 to the outside and is used later as the path into which the liquid crystal is injected.

The alignment liquid, the liquid crystal material, or the like may be injected into the micro-cavity 305 through the injecting hole 307b.

The supporting member 365 is formed in a column shape in the micro-cavity 305 to be adjacent to the opening 307a. The supporting members 365 are each formed at the facing edges of two different micro-cavities 305 as illustrated in FIGS. 3 and 5.

One opening 307a and one injecting hole 307b are formed in one micro-cavity 305. For example, the opening 307a and the injecting hole 307b are each positioned at the upper edge and the lower edge of one micro-cavity 305. The supporting member 365 is formed in the opening 307a but not in the injecting hole 307b. For example, the supporting member 365 may be formed to be adjacent to the opening 307a positioned at the upper edge of the micro-cavity 305. However, there may be no supporting member 365 formed adjacent to the injecting hole 307b positioned at the lower edge of the micro-cavity 305.

That is, the opening 307a and the injecting hole 307b are repeatedly formed in an alternating manner (e.g., the opening 307a, the injecting hole 307b, the opening 307a, and the injecting hole 307b) in a column/vertical direction of the pixel PX.

The supporting member 365 is formed to be adjacent to both sides of the opening 307a as illustrated in FIGS. 1, 3, and 5, and is not formed to be adjacent to both sides of the injecting hole 307b as illustrated in FIGS. 1, 4, and 6. According to an exemplary embodiment, the supporting member 365 may be formed to be adjacent to both sides of an even-numbered horizontal valley V1 but not be formed adjacent to an odd-numbered horizontal valley V1.

The first alignment layer 11 and the second alignment layer 21 may be formed by injecting the alignment liquid in which the alignment material is solved in a solvent. During a process of drying the alignment liquid, an alignment layer aggregating phenomenon in which solids are concentrated on one side and the alignment material becomes aggregated occurs. Since this aggregation may cause light leakage, a decrease in transmissivity, or the like, display quality may be adversely affected.

According to an exemplary embodiment, since the supporting member 365 is formed to be adjacent to the opening 307a positioned at the edge of one side of the micro-cavity 305, capillary forces in the opening 307a and the injecting hole 307b formed in one micro-cavity 305 are different from each other. Since the capillary force in the opening 307a with the supporting member 365 is relatively large, the alignment layer aggregating phenomenon occurs near where the supporting member 365 is formed, that is, around the opening 307a. Therefore, by controlling the locations of the supporting member 365 according to an exemplary embodiment, it is possible to allow the aggregation phenomenon of the alignment layer to occur at the edge of the first sub-pixel PXa or the second sub-pixel PXb. In addition, as illustrated in FIG. 5, since the light shielding member 220 is formed to overlap with the supporting member 365, any obvious visual artifacts that would result from the aggregation of the alignment layer would be avoided.

The sagging of the roof layer 360 occurs in the portion where the alignment layer aggregates. In the display device according to an exemplary embodiment, since the roof layer 360 is supported by the supporting member 365 near the opening 307a where the aggregation of alignment layer occurs, deformation of the roof layer 360 may be prevented.

The supporting member 365 may be connected to the roof layer 360 and may be made of the same material as that of the roof layer 360.

The supporting member 365 according to an exemplary embodiment is formed to be adjacent to the edge of the opening 307a. Therefore, the aggregation phenomenon of the alignment layer may occur at points that are further away from the edges of the first sub-pixel PXa and the second sub-pixel PXb. As a result, a region forming the light shielding member 220 may be further decreased, thereby increasing the aperture ratio.

The width D1 of the opening 307a is small, thus increasing the aperture ratio. The width D2 of the injecting hole 307b is formed larger than the width D1 of the first opening 307a to accommodate the injection of an alignment material and a liquid crystal material.

That is, as described above, the liquid crystal 310 is not injected into the opening 307a having the width D1 and is injected through the injecting hole 307b having the width D2 that is greater than the width D1.

In an exemplary embodiment, the width D1 of the opening 307a may be 10 to 30 μm and the width D2 of the injecting hole 307b may be 40 to 60 μm. However, the inventive concept is not limited thereto.

When the width D1 of the opening 307a is 30 μm or more, the region occupied by the light shielding member 220 formed in the injecting hole 307b is increased, such that the benefit of increased aperture ratio may not be realized significantly.

In addition, since the injecting hole 307b is used as a path by which the alignment material and the liquid crystal material are injected, the injection of the alignment material and the liquid crystal material may not happen smoothly when the width of the injecting hole 307b is 40 μm or less. Furthermore, the region occupied by the light shielding member 220 formed in the injecting hole 307b would be excessively increased, such that the aperture ratio may decrease when the width of the injecting hole 307b is 60 μm or more.

The third insulating layer 350 and the common electrode 270 may be further positioned below the supporting member 365. The supporting member 365 may overlap with the pixel electrode 191. In this case, the common electrode 270 may also overlap with the pixel electrode 171. Since the second insulating layer 250 is formed on the pixel electrode 191, it is possible to prevent a short-circuit from forming between the common electrode 270 and the pixel electrode 191.

According to an exemplary embodiment of the inventive concept, the supporting member 365 may be made of a material different from that of the roof layer 360, and the third insulating layer 350 and the common electrode 270 may not be positioned below the supporting member 365. In this case, the supporting member 365 may be formed immediately on the pixel electrode 191 or may be formed immediately on the second insulating layer 250 or the first insulating layer 240. In addition, when forming the light shielding member 220 or the insulating layers 240 and 250, some of the light shielding member 220 or the insulating layers 240 and 250 protrude using a micro-slit exposure method, or the like, such that the supporting member 365 may be formed.

A plurality of supporting members 365, for example two or three supporting members 365, may be formed at the edge of one side of one micro-cavity 305. The number of supporting members 365 may be increased or decreased depending on the size of the micro-cavity 305. The supporting member 365 may have approximately a quadrangular shape, but is not limited thereto, and may be formed in any suitable shape such as a circular shape, a polygonal shape, and the like.

A step member 362 may be formed between the supporting member 365 and the roof layer 360. The step member 362 may have a width wider than that of the supporting member 365. The step member 362 may be made of the same material as that of the supporting member 365. In addition, the step member 362, the supporting member 365, and the roof layer 360 may also be all made of the same material.

A fourth insulating layer 370 may be further formed on the roof layer 360. The fourth insulating layer 370 may be made of an inorganic insulating material such as silicon nitride (SiNx), silicon oxide (SiOx), or the like. The fourth insulating layer 370 may be formed to cover the top surface and the side surfaces of the roof layer 360. The fourth insulating layer 370 serves to protect the roof layer 360 made of an organic material and may be omitted in some embodiments.

A cover layer 390 may be further formed on the fourth insulating layer 370. The cover layer 390 is formed to cover the injecting hole 307 that extends between the inside of the micro-cavity and the outside. That is, the cover layer 390 seals the micro-cavity 305 so that the liquid crystal molecule 310 is not leaked after filling the liquid crystal into the micro-cavity 305. Since the cover layer 390 is in contact with the liquid crystal molecule, it may be made of a material such as parylene which does not react with the liquid crystal molecule 310.

The cover layer 390 may be formed of a multilayer such as a bi-layer or a triple-layer. The bi-layer includes two layers made of different materials. The triple-layer includes three layers, wherein the layers adjacent to each other are made of different materials. For example, the cover layer 390 may include a layer made of an organic insulating material and a layer made of an inorganic insulating material.

Although not illustrated, polarizing plates may be further formed on upper and lower surfaces of the display device. The polarizing plate may include a first polarizing plate and a second polarizing plate. The first polarizing plate may be attached onto the lower surface of the substrate 110 and the second polarizing plate may be attached onto the cover layer 390.

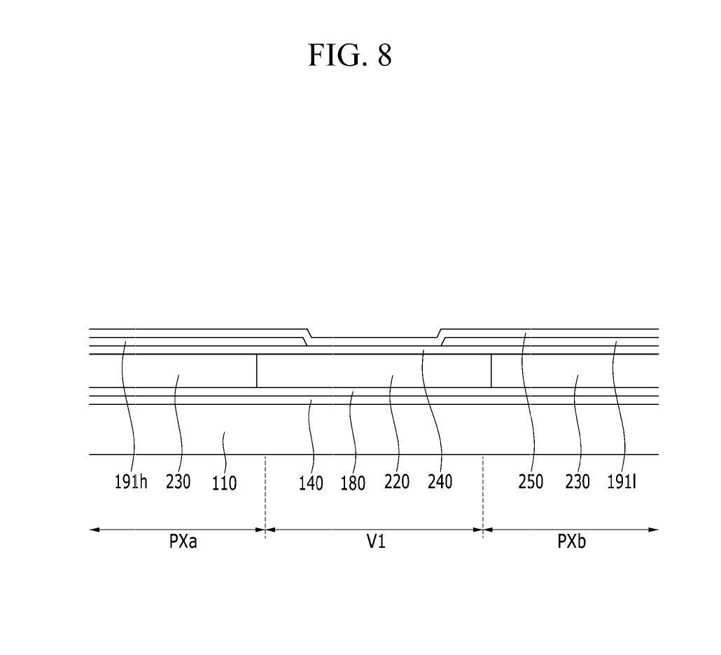

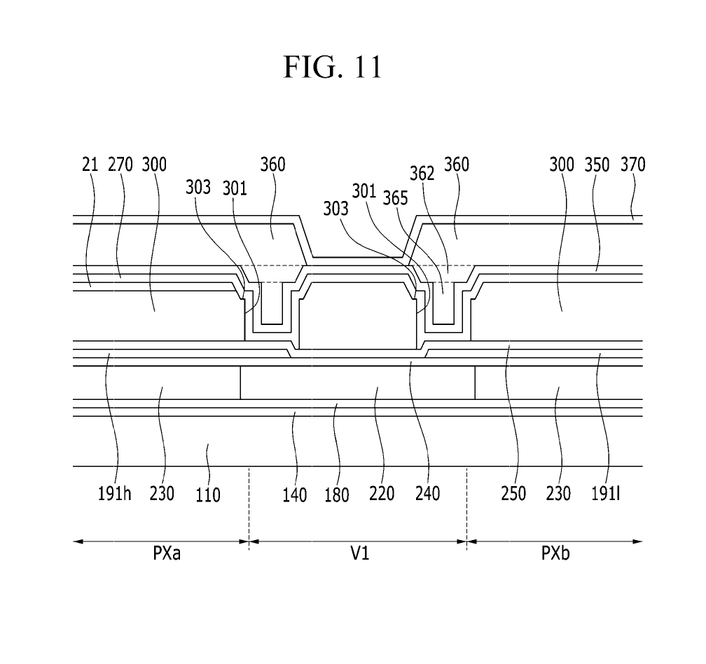

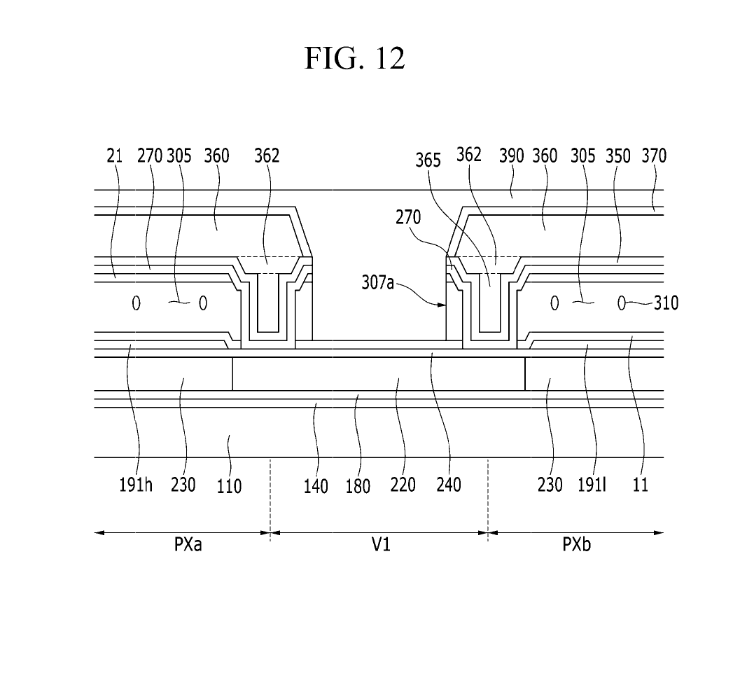

Next, a manufacturing method of a display device according to an exemplary embodiment will be described with reference to FIGS. 8 to 12. Further, the description will be also provided with reference to FIGS. 1 to 7.

FIGS. 8 to 12 are cross-sectional views sequentially illustrating a manufacturing method of a display device according to an exemplary embodiment of the inventive concept.

As illustrated in FIG. 8, the gate line 121 and the decompression gate line 123 which extend in the horizontal direction are formed on the substrate 110 made of glass, plastic, or the like, and the first gate electrode 124h, the second gate electrode 124l, and the third gate electrode 124c that protrude from the gate line 121, are formed. In addition, the sustain electrode line 131 which is spaced apart from the above-mentioned components may also be formed.

Next, the gate insulating layer 140 is formed on a front surface of the substrate 110 having the gate line 121, the decompression gate line 123, the first to third gate electrodes 124h, 124l, and 124c, and the sustain electrode line 131 formed thereon, using the inorganic insulating material such as a silicon oxide (SiOx) or silicon nitride (SiNx). The gate insulating layer 140 may be formed of a single film or multiple films.

Next, a semiconductor material such as an amorphous silicon, a polycrystalline silicon, or a metal oxide is deposited on the gate insulating layer 140 and is then patterned to thereby form the first semiconductor 154h, the second semiconductor 154l, and the third semiconductor 154c. The first semiconductor 154h may be formed to be positioned on the first gate electrode 124h, the second semiconductor 154l may be formed to be positioned on the second gate electrode 124l, and the third semiconductor 154c may be formed to be positioned on the third gate electrode 124c.

Next, a metal material is deposited and is then patterned to thereby form the data line 171 that extends in the vertical direction. The metal material may be formed of a single layer or multiple layers. In addition, the first source electrode 173h which protrudes from the data line 171 onto the first gate electrode 124h and the first drain electrode 175 that is spaced apart from the first source electrode 173h are formed together. In addition, the second source electrode 173l connected to the first source electrode 173h and the second drain electrode 175l which are spaced apart from the second source electrode 173l are formed together. The third source electrode 173c extends from the second drain electrode 175l and the third drain electrode 175c, which is spaced apart from the third source electrode 173c. The third source electrode 173c and the third drain electrode 175c are formed together.

The first to third semiconductors 154h, 154l, and 154c, the data line 171, the first to third source electrodes 173h, 173l, and 173c, and the first to third drain electrodes 175h, 175l, and 175c may be formed by sequentially depositing the semiconductor material and the metal material, and then simultaneously patterning the semiconductor material and the metal material. In this case, the first semiconductor 154h is formed to extend below the data line 171.

Next, the passivation layer 180 is formed on the semiconductors 154h, 154l, and 154c exposed between the data line 171, the first to third source electrodes 173h, 173l, and 173c, the first to third drain electrodes 175h, 175l, and 175c and the respective source electrodes 173c, 173l, and 173c, and the respective drain electrodes 175h, 175l, and 175c. The passivation layer 180 may be made of an organic insulating material or an inorganic insulating material, and may be formed of a single film or multiple films.

Next, the color filter 230 is formed in each pixel PX on the passivation layer 180. The color filter 230 may be formed in each of the first sub-pixel PXa and the second sub-pixel PXb, and may not be formed in the horizontal valley V1. In addition, the color filter 230 of the same color may be formed along the column direction of the plurality of pixels PX. In the case in which the color filter 230 of three colors is formed, the color filer 230 of a first color is first formed and a mask is then shifted, thereby making it possible to form the color filter 230 of a second color. Next, the color filter 230 of the second color is formed and the mask is then shifted, thereby making it possible to form the color filter of a third color.

Next, the light shielding member 220 is formed on a boundary part of each pixel PX on the passivation layer 180 and the thin film transistor. The light shielding member 220 may also be formed in the horizontal valley V1 positioned between the first sub-pixel (PXa) and the second sub-pixel (PXb). Further, the light shielding member 220 is also formed at the edge of one side of each pixel PX. The light shielding member 220 is formed to correspond to a portion overlapping with the supporting member 365 to be formed later. Depending on the exemplary embodiment, the light shielding member 220 is formed first, followed by the color filter 230.

Next, the first insulating layer 240 is formed on the color filter 230 and the light shielding member 220 using an inorganic insulating material such as silicon nitride (SiNx), silicon oxide (SiOx), or the like.

Next, by etching the passivation layer 180, the light shielding member 220, and the first insulating layer 240, the first contact hole 185h is formed so as expose a part of the first drain electrode 175h, and the second contact hole 185h is formed so as to expose a part of the second drain electrode 175l.

Next, the transparent conductive material such as indium tin oxide (ITO), indium zinc oxide (IZO), or the like is deposited on the first insulating layer 240 and is then patterned to thereby form the first sub-pixel electrode 191h in the first sub-pixel PXa and form the second sub-pixel electrode 191l in the second sub-pixel PXb. The first sub-pixel electrode 191h and the second sub-pixel electrode 191l are separated from each other, having the horizontal valley V1 therebetween. The first sub-pixel electrode 191h is formed to be connected to the first drain electrode 175h through the first contact hole 185h, and the second sub-pixel electrode 191l is formed to be connected to the second drain electrode 175l through the second contact hole 185l.

Each of the first sub-pixel electrode 191h and the second sub-pixel electrode 191l is provided with the horizontal stem parts 193h and 193l and the vertical stem parts 192h and 192l intersecting with the horizontal stem parts 193h and 193l. In addition, a plurality of fine branch parts 194h and 194l which are obliquely extended from the horizontal stem part 193h and 193l and the vertical stem parts 192h and 192l are formed.

Next, the second insulating layer 250 may be further formed on the pixel electrode 191 using an inorganic insulating material such as silicon nitride (SiNx), silicon oxide (SiOx), or the like. The second insulating layer 250 is a member which is formed to prevent a short-circuit from forming between the common electrode 270 and the pixel electrode 191. Therefore, in the case in which the supporting member 365 does not overlap with the pixel electrode 191, a process of forming the second insulating layer 250 may be omitted.

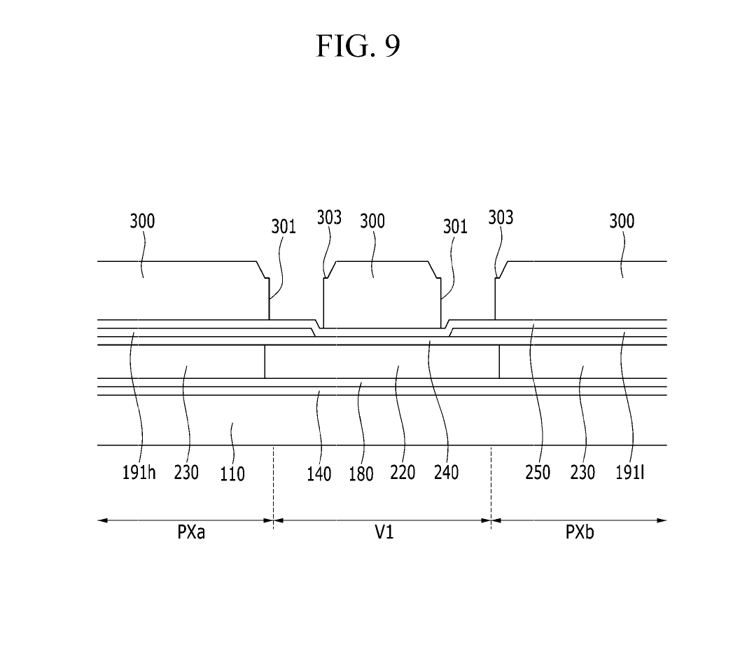

As illustrated in FIG. 9, a sacrificial layer 300 is formed by applying a photosensitivity organic material on the pixel electrode 191 and performing a photo process.

The sacrificial layers 300 are formed to be connected to each other along the plurality of pixel columns. That is, the sacrificial layer 300 is formed to cover each pixel PX and is formed to cover the horizontal valley V1 positioned between the first sub-pixel PXa and the second sub-pixel PXb. That is, the photosensitivity organic material positioned in the vertical valley V2 is removed by the photo process. In addition, a hole part 301 is formed by removing the portion of the sacrificial layer 300 by the photo process. The hole part 301 may be formed to be adjacent to the horizontal valley V1. The second insulating layer 250 positioned below the photosensitivity organic material is exposed by forming the hole part 301. In addition, when the hole part 301 is formed, a groove part 303 is further formed by performing slit exposure or halftone exposure around the opening 301. In order to form the groove part 303, the sacrificial layer 300 may be patterned using a slit mask or a halftone mask. Since the groove part 303 is formed by developing a portion of the sacrificial layer 300, a portion of the sacrificial layer 300 where the groove part 303 is formed is thinner than other portions. The groove part 303 may be formed to surround the hole part 301.

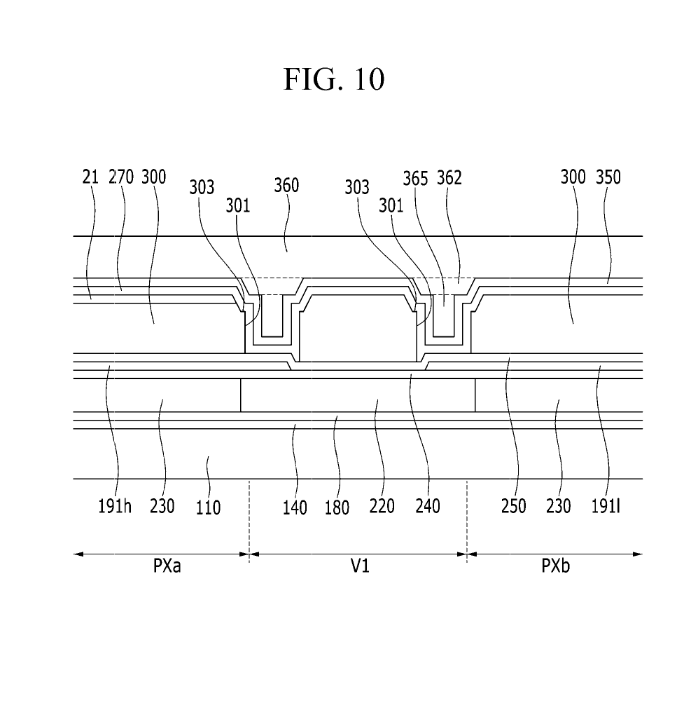

As illustrated in FIG. 10, the common electrode 270 is formed by depositing a transparent conductive material such as an indium tin oxide (ITO), an indium zinc oxide (IZO), or the like on the sacrificial layer 300.

Next, the third insulating layer 350 may be formed on the common electrode 270 using an inorganic insulating material such as silicon oxide or silicon nitride.

Next, the roof layer 360 is formed on the third insulating layer 350 using an organic material and the supporting member 365 is formed in the opening 301. The roof layer 360 and the supporting member 365 may be formed using the same material in the same process.

During a process of forming the roof layer 360 and the supporting member 365, the step member 362 may be formed in the groove part 303 of the sacrificial layer 300. By forming the third insulating layer 350 and then applying an organic material on the entire substrate 110, the roof layer 360, the supporting member 365, and the step member 362 may be simultaneously formed. That is, the roof layer 360, the supporting member 365, and the step member 362 may be formed using the same material in the same process.

The common electrode 270 and the third insulating layer 350 may be positioned below the roof layer 360 and the supporting member 365. The supporting member 365 may be formed to overlap the pixel electrode 191. In this case, since the second insulating layer 250 is formed on the pixel electrode 191, it is possible to prevent a short-circuit from forming between the common electrode 270 and the pixel electrode 191. The supporting member 365 is formed in a column shape, and plane shape of the supporting member 365 when being viewed from the upper surface of the substrate 110, may be various shapes such as a circular shape, polygonal shape, and the like.

The roof layer 360 positioned in the horizontal valley V1 may be removed by patterning the roof layer 360. Therefore, the roof layers 360 may be formed in a shape connected to each other along the plurality of pixel rows.

The supporting member 365 according to an exemplary embodiment may be formed adjacent to the edge of the opening 307a. Therefore, the aggregation of alignment layer may occur further away from the first sub-pixel PXa and the second sub-pixel PXb. As a result, a region forming the light shielding member 220 may be further decreased, thereby increasing the aperture ratio.

As the first horizontal valley has a width D1 that is smaller than the width D2 of the second horizontal valley, the length of the roof layer 360 in the column direction is increased compared to the case where all the horizontal valleys have a width D2 (given that the substrate size remains unchanged). In some embodiments, the vertical length of the roof layer 360 alternates between longer and shorter lengths in the vertical direction, to reflect the alternating width of the horizontal valleys. For example, one row of roof layers 360 may have a vertical length that is longer than the roof layers 360 in the neighboring row by the difference D2−D1.

Where the width D1 of the opening 307a and the width D2 of the injecting hole 307b are formed to be the same, since the supporting member 365 is positioned at a certain minimum distance away from the opening 307a, the light shielding member 220 needs to be wider than the width of the opening or the injection hole. Consequently, the aperture ratio may be decreased.

The inventive concept allows the light shielding member 220 formed in the opening 307a to be narrower without increasing light leakage, because the width D1 of the opening 307a is made narrower and the structure of the supporting member 365 allows it to be formed close to the opening 307a. In addition, the same width of the light shielding member 220 is positioned in the injecting hole 307b as in the opening 307a because no supporting member 365 is formed adjacent to the injecting hole 307b (see FIG. 2B). If supporting members 365 were to be formed at the injection hole 307b, the light shielding member 220 would have to be wider at the injection hole 307b. This is avoided by rearranging the supporting structures 365 to the two edges adjacent to the opening 307a.

The narrowing of every other horizontal valley from D2 to D1 results in a narrower light shielding member 220 formed in the opening 307a. Hence, the width D1 of the opening 307a being small increases the aperture ratio. The width D2 of the injecting hole 307b may be formed to be larger than the width D1 of the opening 307a to allow smooth injection of alignment material and liquid crystal material.

Here, the width D1 of the opening 307a may be 10 to 30 μm, and the width D2 of the injecting hole 307b may be 40 to 60 μm. However, these are examples and not a limitation of the inventive concept.

When the width D1 of the opening 307a is 30 μm or more, the region occupied by the light shielding member 220 formed in the opening 307a is increased, such that any benefit from enhanced aperture ratio may not be significant enough.

In addition, since the injecting hole 307b is used as a path for injecting the alignment material and the liquid crystal material, the injection of the alignment material and the liquid crystal material may not be smoothly performed when the width of the injecting hole 307b is 40 μm or less. Furthermore, the region occupied by the light shielding member 220 formed in the injecting hole 307b is excessively increased, such that the aperture ratio may be decreased when the width of the injecting hole 307b is 60 μm or more.

Next, the fourth insulating layer 370 may be formed on the roof layer 360 using an inorganic insulating material such as silicon nitride (SiNx), silicon oxide (SiOx), or the like. Since the fourth insulating layer 370 is formed on the patterned roof layer 360, it may cover and protect the side surfaces of the roof layer 360. Next, the fourth insulating layer 370, the third insulating layer 350, and the common electrode 270 which are positioned in the horizontal valley V1 are removed by patterning the fourth insulating layer 370, the third insulating layer 350, and the common electrode 270. As the roof layer 360 and the common electrode 270 are patterned, the sacrificial layer 300 positioned in the horizontal valley V1 is exposed to the outside.

Next, the sacrificial layer 300 is removed by supplying a developing solution on the substrate 110 having the exposed sacrificial 300. Alternatively, the sacrificial layer 300 is removed using an ashing process. Once the sacrificial layer 300 is removed, the micro-cavity 305 is formed where the sacrificial layer 300 was.

The pixel electrode 191 and the common electrode 270 are spaced apart from each other with the micro-cavity 305 therebetween, and the pixel electrode 191 and the roof layer 360 are spaced apart from each other, having the micro-cavity 305 therebetween. The common electrode 270 and the roof layer 360 are formed to cover the upper surface and both side surfaces of the micro-cavity 305.

The micro-cavity 305 is connected to the outside through a portion of its wall from which the roof layer 360 and the common electrode 270 are removed to thereby form the opening 307a and the injecting hole 307b, and the opening 307a and the injecting hole 307b may be formed along the horizontal valley V1. For example, the opening 307a and the injecting hole 307b may be formed to face each other at the edges of the first sub-pixel PXa and the second sub-pixel PXb. That is, the opening 307a and the injecting hole 307b may be formed to expose the side surfaces of the micro-cavity 305 corresponding to a lower edge of the first sub-pixel PXa and an upper edge of the second sub-pixel PXb. Unlike this, the opening 307a and the injecting hole 307b may be formed along the vertical valley V2.

Hereinafter, a position relationship between the opening 307a and the injecting hole 307b, and the supporting member 365 will be described. The supporting member 365 is formed in the micro-cavity 305 adjacent to the opening 307a. One opening 307a and one injecting hole 307b may be formed in one micro-cavity 305, and the supporting member 365 is formed to be adjacent to the opening 307a.

That is, the opening 307a and the injecting hole 307b are repeatedly formed in an alternating manner (e.g., the opening 307a, the injecting hole 307b, the opening 307a, and the injecting hole 307b) in a column direction of the pixel PX.

Describing a position of the supporting member 365 based on the horizontal valley V1, the supporting member 365 is formed to be adjacent to both sides of the horizontal valley V1. The supporting member 365 is formed to be adjacent to a first horizontal valley but is not formed to be adjacent to a second horizontal valley of the other. The plurality of supporting members 365 may be formed at an edge of the micro-cavity 305.

In addition, as described above, the liquid crystal 310 is not injected into the opening 307a having the width D1 and is injected through the injecting hole 307b having the width D2 greater than D1.

Next, the roof layer 360 is hardened by applying heat to the substrate 110. This is to maintain the shape of the micro-cavity 305 by the roof layer 360.

In the case in which the alignment liquid containing the alignment material drops on the substrate 110 using a spin coating method or an inkjet method, the alignment liquid is injected into the micro-cavity 305 through the injecting hole 307b. Since the supporting members 365 are not formed to be adjacent to each other, the alignment liquid drops only on the injecting hole 307b which is formed to have a relatively wide width. Once the alignment liquid is injected into the micro-cavity 305 and a hardening process is then performed, solution contents are evaporated and the alignment material remains on inner wall surfaces of the micro-cavity 305. Therefore, the first alignment layer 11 may be formed on the pixel electrode 191 and the second alignment layer 21 may be formed below the common electrode 270. The first alignment layer 11 and the second alignment layer 21 are formed to face each other, having the micro-cavity 305 therebetween, and are formed at the edge of the pixel PX so as to be connected to each other.

The first and second alignment layers 11 and 21 may have alignment formed in a direction perpendicular to the substrate 110 except for the side surfaces of the micro-cavity 305. Additionally, the alignment may be formed in a horizontal direction with the substrate 110 by irradiating ultraviolet (UV) onto the first and second alignment layers 11 and 21.

During a process of drying the alignment liquid, solids are concentrated on one side, such that an alignment layer aggregation occurs. According to an exemplary embodiment, since the supporting member 365 is formed to be adjacent to the opening 307a positioned at the edge of one side of the micro-cavity 305, capillary forces in the opening 307a and the injecting hole 307b formed in one micro-cavity 305 are different from each other. Since the capillary force in the opening 307a in which the supporting member 365 is formed is relatively large, the aggregation occurs around the opening 307a at which the supporting member 365 is formed.

In the display device according to an exemplary embodiment, the alignment layer aggregating phenomenon occurs only at a position adjacent to the openings 307a positioned at both sides of the first horizontal valley in which the supporting member 365 is formed. That is, if the supporting member 365 is formed to be adjacent to both sides of the odd-numbered horizontal valley V1, the alignment layer aggregating also occurs at the position adjacent to both sides of the odd-numbered horizontal valley V1. On the contrary, if the supporting member 365 is formed to be adjacent to both sides of the even-numbered horizontal valley V1, the alignment layer aggregating phenomenon also occurs at the position adjacent to both sides of the even-numbered horizontal valley V1.

Next, in the case in which the liquid crystal material containing the liquid crystals 310 drops on the substrate 110 using an inkjet method or a dispensing method, the liquid crystal material is injected into the micro-cavity 305 through the injecting hole 307b. That is, since the supporting members 365 are not formed to be adjacent to each other, the liquid crystal material drops on the injecting hole 307b which is formed to have a relatively wide width, similar to the alignment liquid. For example, if the supporting member 365 is formed adjacent to both sides of the first horizontal valley V1-1, the liquid crystal material drops on the second horizontal valley V1-2 and does not need to drop on the first horizontal valley V1-1. On the contrary, if the supporting member 365 is formed adjacent to both sides of the second horizontal valley V1-2, the liquid crystal material drops on the first horizontal valley V1-1 and does not need to drop on the second horizontal valley V1-2.

That is, in the case in which the supporting member 365 is formed to be adjacent to both sides of the first horizontal valley V1-1, when the liquid crystal material drops on the injecting hole 307b formed along the second horizontal valley V1-2, the liquid crystal material is injected into the micro-cavity 305 through the injecting hole 307b by capillary force.

Although the opening 307a adjacent to the supporting member 365 has a gap (part of the horizontal valley V1), it is difficult to inject the liquid crystal material into the opening 307a due to the aggregation of the alignment layer and the width D1 of the opening 307a which is formed to be relatively narrow. According to an exemplary embodiment, if the supporting member 365 is formed in the odd-numbered horizontal valley V1, the liquid crystal material drops on the even-numbered horizontal valley V1 and not on the first horizontal valley V1. For example, if the supporting member 365 is formed at the upper edge of each micro-cavity 305, the liquid crystal material will be injected through the injecting hole 307b positioned at the lower edge of the micro-cavity 305. Therefore, the liquid crystal material is dropped on both the even-numbered horizontal valley V1 and the odd-numbered horizontal valley V1.

In a process of manufacturing the display device according to an exemplary embodiment, since the liquid crystal material drops on either the odd-numbered horizontal valley V1 or the even-numbered horizontal valley V1, processing time may be shortened compared a case where the liquid crystal material is dropped on all the horizontal valleys V1. Cost may also be reduced due to the shortening of the processing time described above.

Next, the cover layer 390 is formed by depositing a material which does not react with the liquid crystal molecule 310 on the fourth insulating layer 370. The cover layer 390 is formed to cover the injecting hole 307 exposing the micro-cavity 305 to the outside to thereby seal the micro-cavity 305.

Next, although not illustrated, the polarizing plates may be further attached onto upper and lower surfaces of the display device. The polarizing plate may include a first polarizing plate and a second polarizing plate. The first polarizing plate may be attached onto the lower surface of the substrate 110 and the second polarizing plate may be attached onto the cover layer 390.

As described above, since the deformation of the roof layer is prevented by the supporting member and the supporting members are formed at the two different facing edges of the micro-cavity, the position at which the aggregation of alignment material occurs may be controlled, and the width of the liquid crystal injecting hole of the portion at which the supporting member is positioned is formed to be narrow, such that the region occupied by the light shielding member may be reduced, thereby increasing the aperture ratio.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

<Description of symbols>

| 11, 21: alignment layer | | 110: substrate | |
|---|---|---|---|
| 121: gate line | 123: decompression gate line | | |
| 124h, 124l, 124c: gate electrode | | | 131: sustain electrode line |
| 140: gate insulating layer | | | 154h, 154l, 154c: semiconductor |
| 171: data line | 173h, 173l, 173c: source electrode | | |
| 175h, 175l, 175c: drain electrode | | | 191: pixel electrode |
| 191h, 191l: sub-pixel electrode | | | 220: light shielding member |
| 230: color filter | 240, 250, 350, 370: insulating layer | | |
| 270: common electrode | | | 300: sacrificial layer |

| 301: opening | 303: groove part | |
|---|---|---|
| 305: micro-cavity | | 307: injecting hole |

| | |
|---|---|
| 308: gap | 310: liquid crystal molecule |
| 360: roof layer | 362: step member |

| | |
|---|---|
| 365: supporting member | 390: cover layer |

| | |
|---|---|
| V1: horizontal valley | V2: vertical valley |

While this inventive has been described in connection with what is presently considered to be practical exemplary embodiments, it is to be understood that the inventive is not limited to the disclosed embodiments, but, on the contrary, is intended to cover various modifications and equivalent arrangements included within the spirit and scope of the appended claims.

What is claimed is:

1. A display device, comprising:
a substrate including a plurality of pixels disposed in a matrix configuration and having a thin film transistor positioned thereon;
a pixel electrode connected to the thin film transistor and positioned in one pixel of the pixels;
a roof layer including an opening and an injecting hole positioned to be spaced apart from the pixel electrode on the pixel electrode, the roof layer enclosing a micro-cavity holding a liquid crystal layer; and
a first supporting member formed at a first edge of the micro-cavity that is adjacent to the opening,
wherein the opening is smaller than the injecting hole.

2. The display device of claim 1, wherein:
the opening has a width of 10 to 30 μm, and
the injecting hole has a width of 40 to 60 μm.

3. The display device of claim 2, further comprising:
an alignment layer positioned on an inner surface of the micro-cavity.

4. The display device of claim 3, wherein:
the supporting member is formed of the same material as that of the roof layer.

5. The display device of claim 4, wherein the opening is between the first edge and a second edge of neighboring micro-cavities and
a second supporting member is formed adjacent to the second edge.

6. The display device of claim 5, wherein:
more than one supporting member is formed at each of the first edge and the second edge of the micro-cavities.

7. The display device of claim 5, wherein:
the alignment layer aggregates around the first and second supporting members.

8. The display device of claim 2, wherein:
the opening and the injecting hole are provided with light shielding members, and
the light shielding members positioned in the opening and the injecting hole have the same width.

9. A manufacturing method of a display device, the method comprising:
forming a thin film transistor on a substrate including a plurality of pixels disposed in a matrix configuration;
in one pixel of the pixels, forming a pixel electrode connected to the thin film transistor;
forming a sacrificial layer on the pixel electrode and forming a hole part by removing a portion of the sacrificial layer;
forming a roof layer and supporting members together on the sacrificial layer and the hole part;
forming an opening and an injecting hole to expose a portion of the sacrificial layer;
forming a micro-cavity by removing the sacrificial layer; and
forming a liquid crystal layer in the micro-cavity by injecting a liquid crystal material through the injecting hole,
forming a first supporting member at a first edge of the opening, wherein
the opening is smaller than the injecting hole.

10. The manufacturing method of claim 9, wherein:
the opening has a width of 10 to 30 μm, and
the injecting hole has a width of 40 to 60 μm.

11. The manufacturing method of claim 10, further comprising:
before the injecting of the liquid crystal material,
forming an alignment layer on an inner surface of the micro-cavity by injecting an alignment liquid through the injecting hole.

12. The manufacturing method of claim 11, further comprising:
forming the supporting member with the same material as the roof layer.

13. The manufacturing method of claim 12, wherein the opening is between the first edge and a second edge of neighboring micro-cavities, further comprising forming the second supporting member adjacent to the second edge.

14. The manufacturing method of claim 13, wherein:
more than one supporting members is formed at each of the first edge and the second edge of the micro-cavities.

15. The manufacturing method of claim 10, further comprising:
forming light shielding members at positions corresponding to the opening and the injecting hole,
wherein the light shielding members formed at the positions corresponding to the opening part and the injecting hole have the same width.

16. The manufacturing method of claim 15, further comprising:
sealing the micro-cavity by forming cover layer on the roof layer.

17. A display device including liquid crystal molecules contained in microcavities, comprising:
a first row of microcavities arranged on a substrate;
a second row of microcavities arranged on the substrate, wherein the second row of microcavities is spaced apart from the first row of microcavities by a first horizontal valley having a width D1;
a third row of microcavities arranged on the substrate, wherein the third row of microcavities is spaced apart from the second row of microcavities by a second horizontal valley having a width D2 different from D1; and
supporting members formed at the edges of the microcavities adjacent to the first horizontal valley but not the second horizontal valley.

18. The display device of claim 17, wherein a width of microcavities in the first row is different from the width of microcavities in the second row, the width being measured in a same direction as the widths D1 and D2.
